(19) United States
(12) Patent Application Publication
(10) Pub. No.: US 2025/0238113 A1
(43) Pub. Date: Jul. 24, 2025

(54) User Interface for Generating a Three-Dimensional Environment

(71) Applicant: Apple Inc., Cupertino, CA (US)

(72) Inventors: Arjun Karanam, Cumming, GA (US); Andrew Mason, Cupertino, CA (US); Pravalika Avvaru, Sunnyvale, CA (US); Sneha S. Bhakare, Mountain View, CA (US)

(21) Appl. No.: 19/026,087

(22) Filed: Jan. 16, 2025

Related U.S. Application Data
(60) Provisional application No. 63/623,213, filed on Jan. 20, 2024.

(51) Int. Cl. G06F 3/04815; G06F 3/04845; G06T 11/00; G06T 19/00

(52) U.S. Cl. CPC G06F 3/04815; G06F 3/04845; G06T 11/00; G06T 19/00; G06T 2200/24

(57) ABSTRACT

A method includes receiving, via a graphical user interface (GUI), a first user input that corresponds to a request to generate a three-dimensional (3D) environment. The method includes after receiving the first user input, displaying, within the GUI, suggested inputs that further characterize the first user input. The method includes displaying two-dimensional (2D) previews of the 3D environment prior to generating the 3D environment where each 2D preview is associated with a corresponding one of the suggested inputs.

### CROSS-REFERENCE TO RELATED APPLICATION

This application claims the benefit of U.S. Provisional Patent App. No. 63/623,213, filed on Jan. 20, 2024, which is incorporated by reference in its entirety.

### TECHNICAL FIELD

The present disclosure generally relates to a user interface for generating a three-dimensional environment.

### BACKGROUND

Some devices can be used to generate a three-dimensional environment. Generating three-dimensional environments tends to be a resource-intensive operation. For example, generating a three-dimensional environment can take a considerable amount of time and may require a considerable amount of computing resources. Making changes to a previously-generated three-dimensional environment often requires generating a new three-dimensional environment which can be as resource-intensive as generating the previously-generated three-dimensional environment.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1N are diagrams of an example operating environment in accordance with some implementations.

FIG. 2 is a diagram of an environment generation system in accordance with some implementations.

FIG. 3 is a flowchart representation of a method of generating an environment in accordance with some implementations.

FIG. 4 is a block diagram of a device that generates an environment in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for generating an environment. In various implementations, a method is performed at an electronic device including a display, an input device, a non-transitory memory and one or more processors. In some implementations, the method includes receiving, via a graphical user interface (GUI), a first user input that corresponds to a request to generate a three-dimensional (3D) environment. In some implementations, the method includes, after receiving the first user input, displaying, within the GUI, suggested inputs that further characterize the first user input. In some implementations, the method includes displaying two-dimensional (2D) previews of the 3D environment prior to generating the 3D environment where each 2D preview is associated with a corresponding one of the suggested inputs.

In accordance with some implementations, a device includes one or more processors, a plurality of sensors, a non-transitory memory, and one or more programs. In some implementations, the one or more programs are stored in the non-transitory memory and are executed by the one or more processors. In some implementations, the one or more programs include instructions for performing or causing performance of any of the methods described herein. In accordance with some implementations, a non-transitory computer readable storage medium has stored therein instructions that, when executed by one or more processors of a device, cause the device to perform or cause performance of any of the methods described herein. In accordance with some implementations, a device includes one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

Generating a three-dimensional (3D) environment can be a resource-intensive operation. The generation of the 3D environment depends on inputs that are provided to a model that generates the 3D environment. As such, providing an unintended input to the model can result in an undesirable 3D environment. Modifying or re-generating the 3D environment can be as resource-intensive as generating the 3D environment anew.

The present disclosure provides methods, systems, and/or devices for providing a user interface that guides a user in providing an input to a model that generates a 3D environment in order to reduce a number of times that the model is invoked. The user interface allows the user to view a two-dimensional (2D) preview of the 3D environment prior to the device generating the 3D environment. The user interface allows the user to edit the 2D preview which is less resource-intensive than editing the 3D environment by invoking the model that generates the 3D environment. Once the user has finished editing the 2D preview, the device can generate the 3D environment by invoking the model. Since the user interface provides the user with an opportunity to edit the 2D preview, the user is less likely to edit the 3D environment thereby conserving resources associating with using the model to edit the 3D environment.

After receiving an initial input that corresponds to a request to generate a 3D environment, the device displays suggested inputs that further characterize the initial input. The user can provide subsequent inputs by selecting one or more of the suggested inputs. The device utilizes the initial input and the subsequent inputs to generate the 3D environment. The suggested inputs can resolve ambiguities in the initial input. When the device displays the suggested inputs, the device can also display 2D previews of the 3D environment where each 2D preview corresponds to one of the suggested inputs. For example, a first 2D preview illustrates what the 3D environment may look like if the user selects a first one of the suggested inputs. Similarly, a second 2D preview illustrates what the 3D environment may look like if the user selects a second one of the suggested inputs. Displaying the previews prior to generating the 3D environment tends to reduce a number of iterations of the 3D environment thereby reducing resource consumption associated with generating the 3D environment.

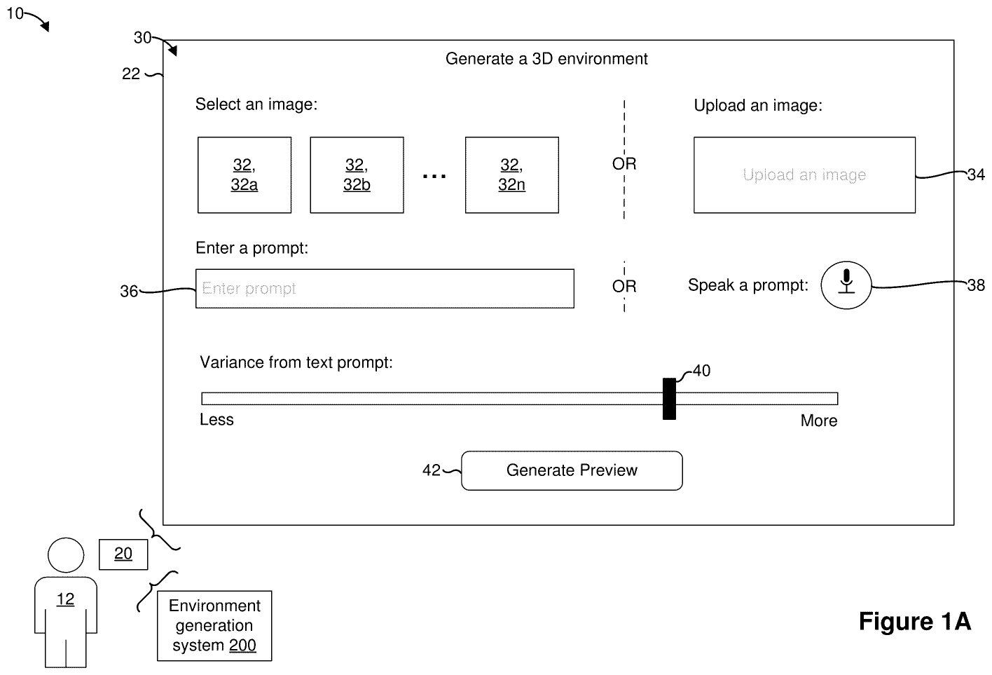

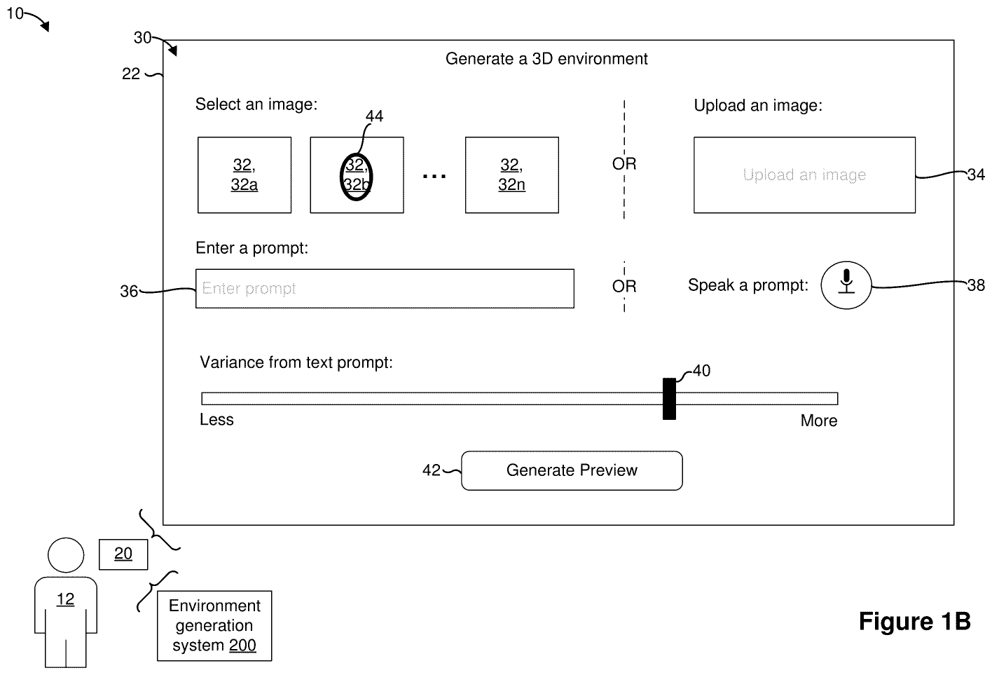

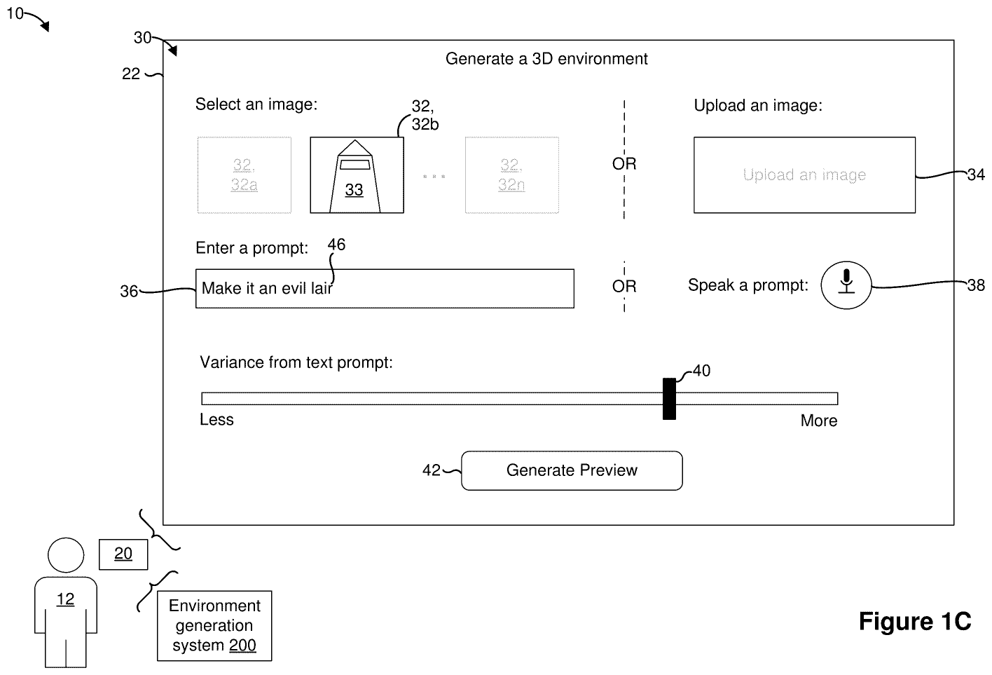

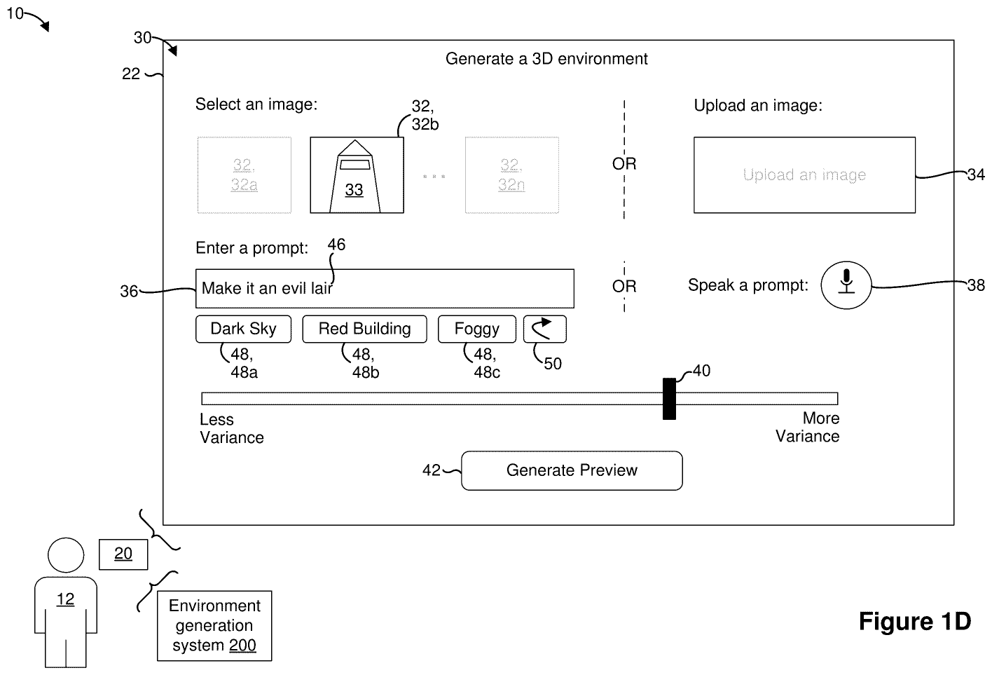

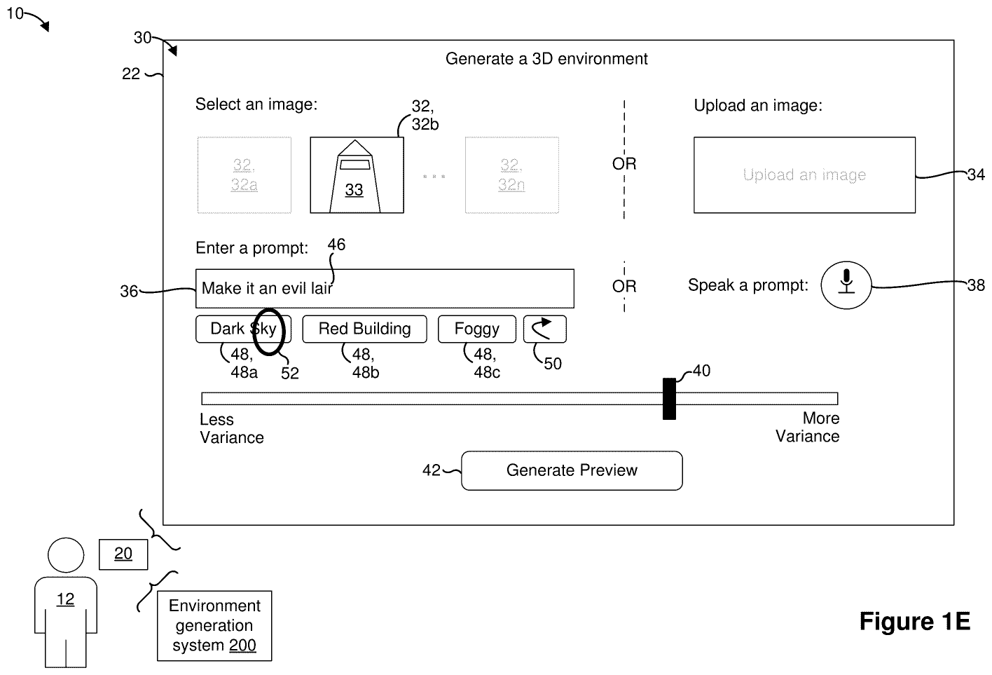

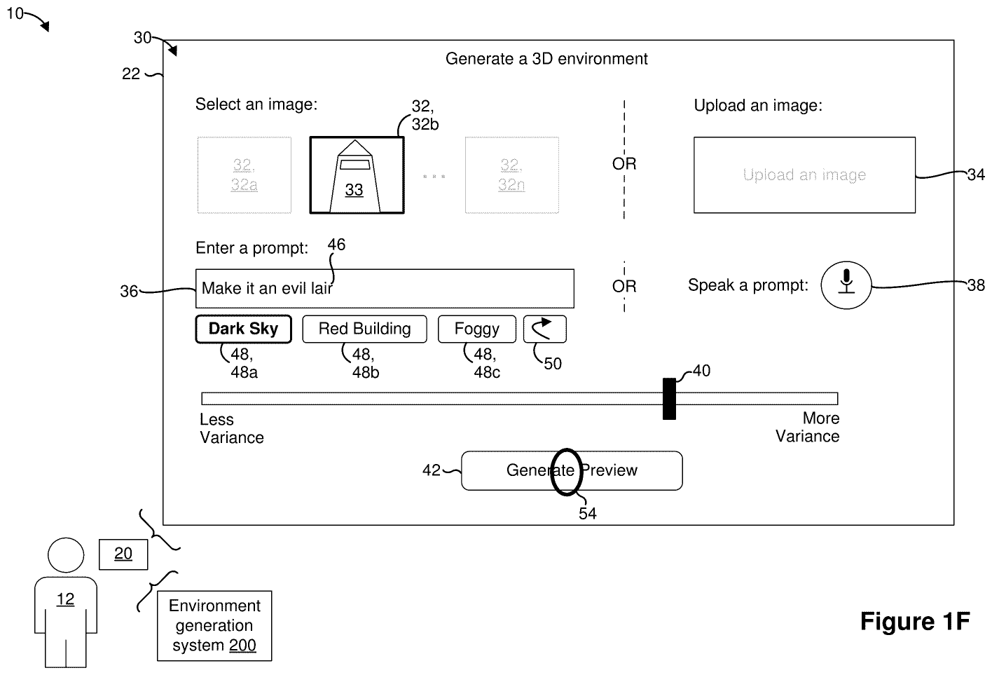

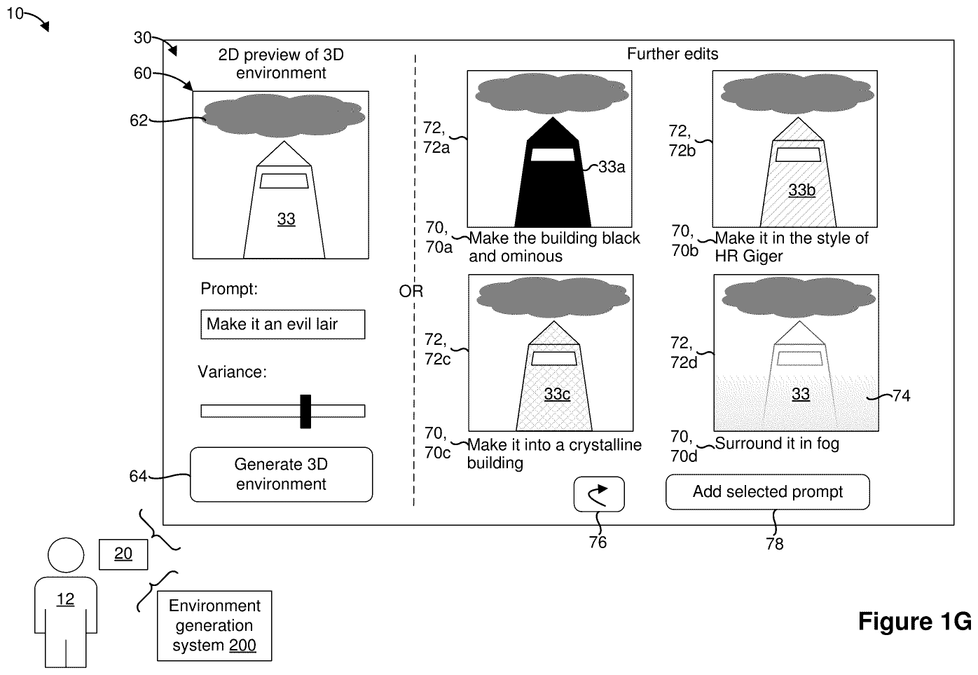

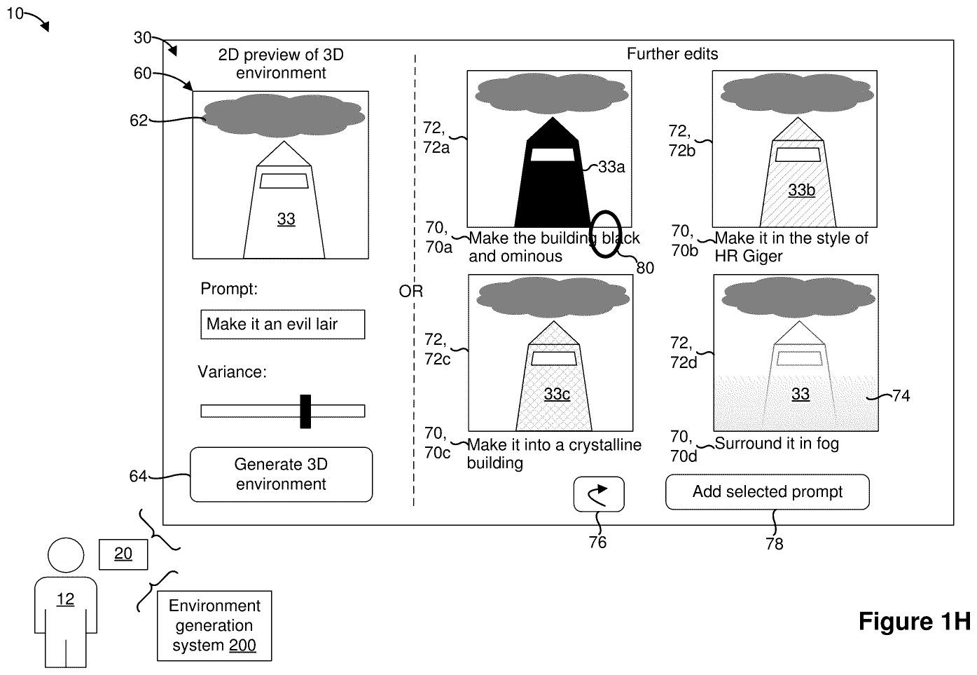

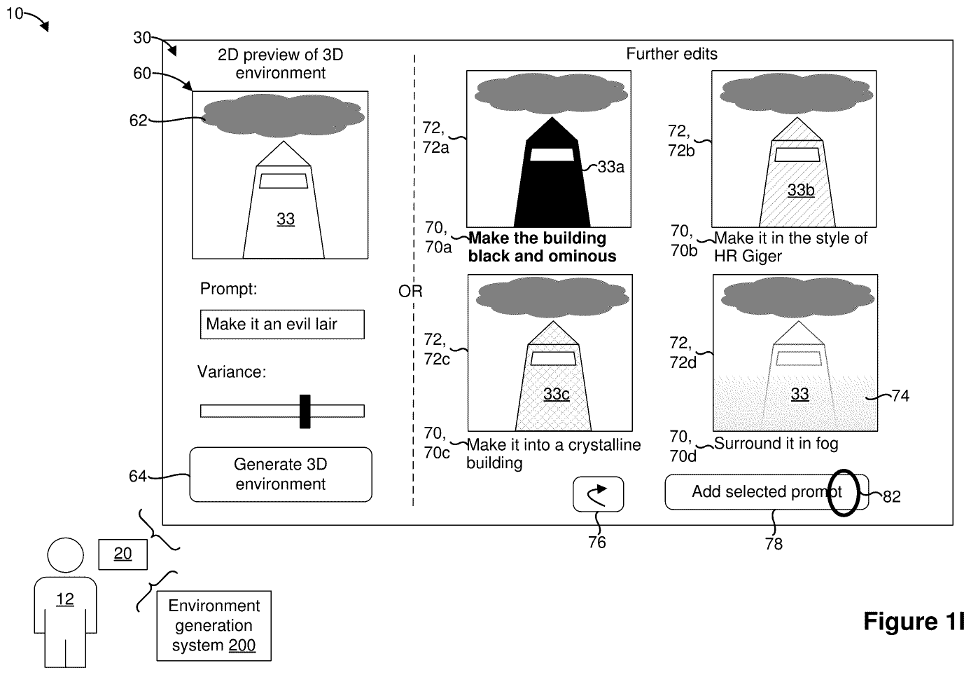

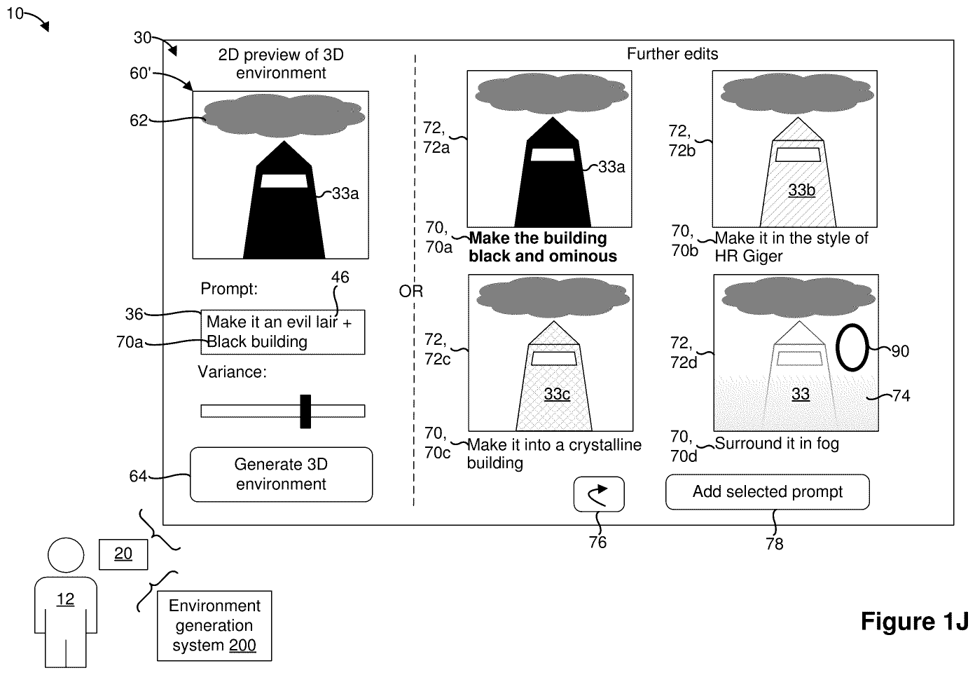

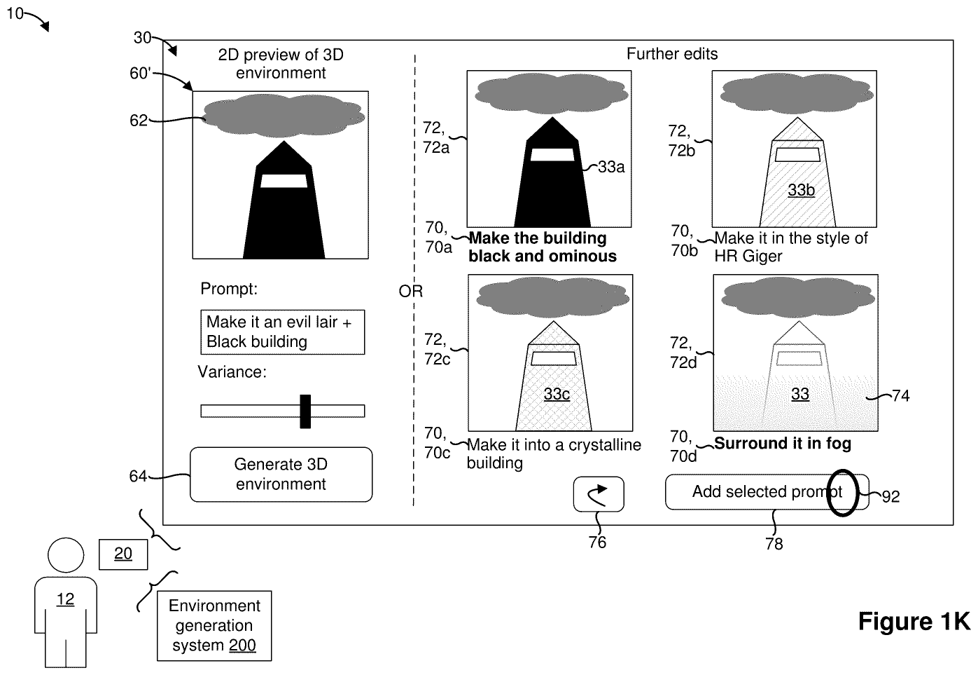

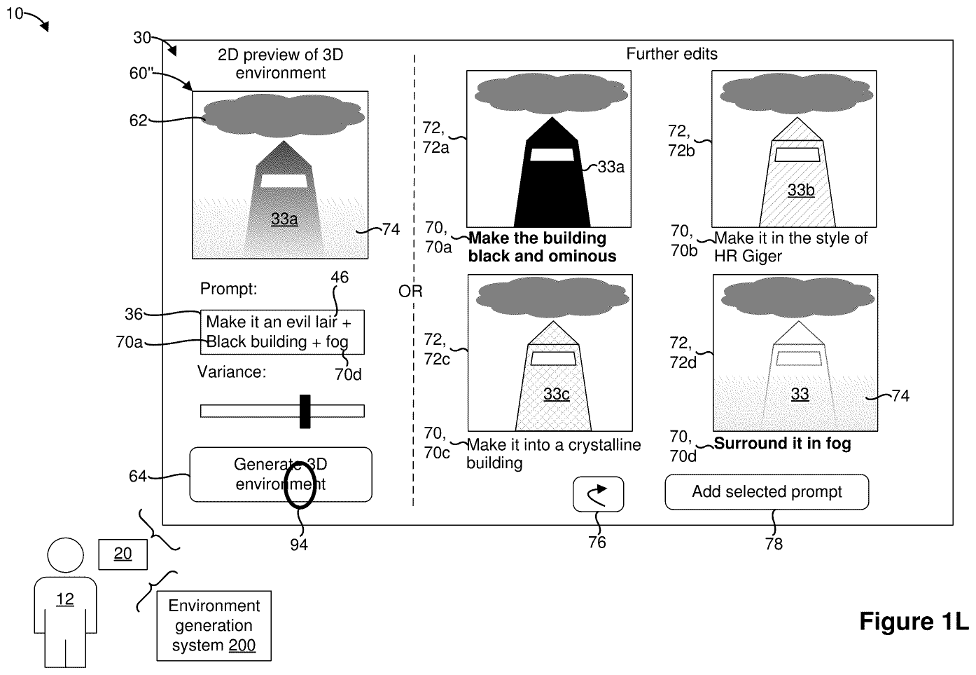

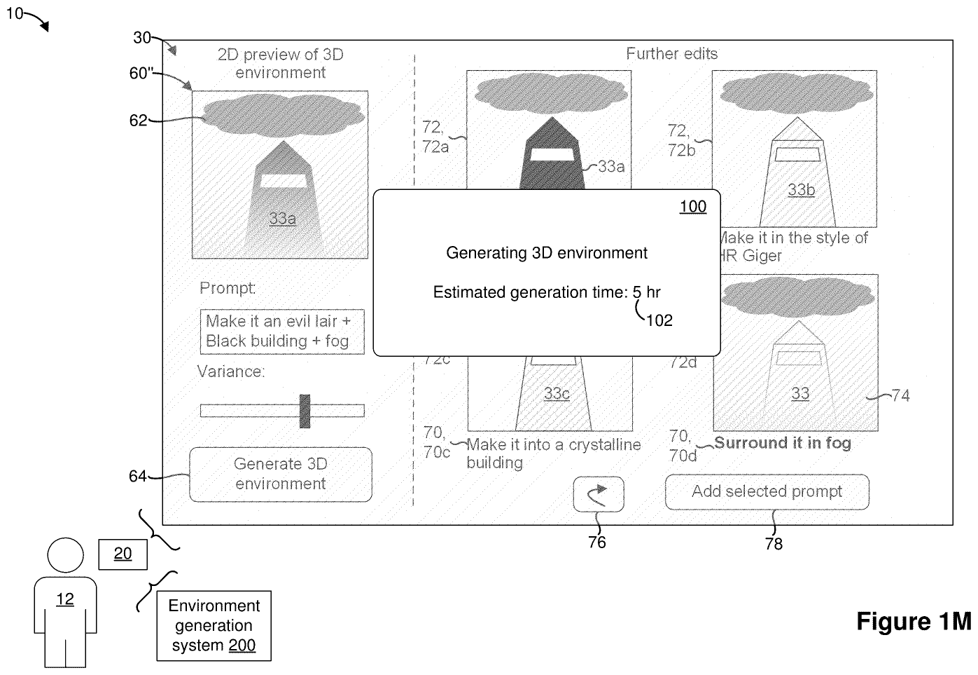

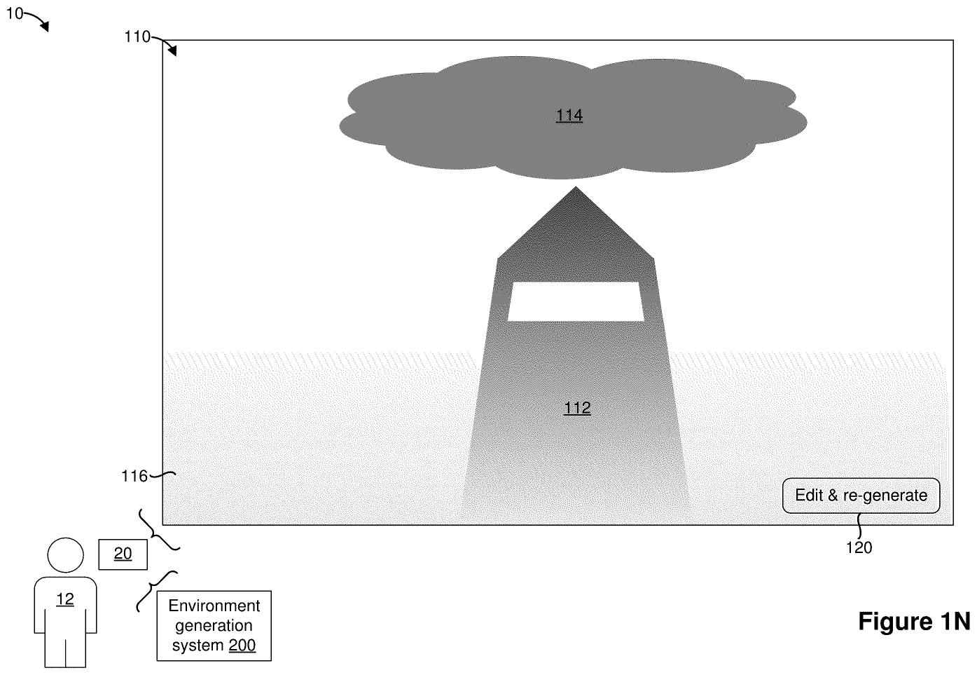

FIG. 1A is a diagram that illustrates an example physical environment 10 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the physical environment 10 includes a device 20 with a display 22 and a user 12 of the device 20.

In various implementations, the device 20 includes an environment generation system 200 (“system 200”, hereinafter for the sake of brevity). The system 200 generates a three-dimensional (3D) environment (e.g., a virtual environment) based on a text prompt and/or an image provided by the user 12. The device 20 displays a graphical user interface (GUI) 30 (“user interface 30”, hereinafter for the sake of brevity) on the display 22. The user interface 30 guides the user 12 in generating the 3D environment. In some implementations, the user interface 30 guides the user 12 in refining the text prompt that the system 200 uses to generate the 3D environment. As an example, the text prompt may include an ambiguous word and the device 20 displays a suggested word that resolves (e.g., reduces) the ambiguity. As another example, the text prompt may specify a desired qualitative characteristic of the 3D environment, and the device 20 displays a suggested quantitative value in order to achieve the desired qualitative characteristic.

In the example of FIG. 1A, the user interface 30 includes various images 32 (e.g., a first image 32a, a second image 32b, . . . , and an nth image 32n). The user 12 can select one or more of the images 32 as a basis for constructing the 3D environment. Additionally or alternatively, the user interface 30 includes an image upload box 34 that the user 12 can use to upload an image instead of or in addition to selecting one of the images 32.

The user interface 30 includes a text box 36 for accepting a text prompt from the user 12. Additionally or alternatively, the user interface 30 includes a mic affordance 38 that the user 12 can tap to start speaking. The device 20 can transcribe spoken words and display a transcript of the spoken words in the text box 36. In some implementations, the text prompt specifies how to construct a 3D environment from one of the selected images 32. For example, the text prompt can specify how to change one of the images 32 in order to generate a desired 3D environment.

The user interface 30 includes a variance slider 40 that allows the user 12 to select a variance range between the text prompt provided by the user 12 and refinements suggested by the system 200. Sliding the variance slider 40 towards the right results in the system 200 suggesting refinements to the text prompt that diverge more from the text prompt than sliding the variance slider 40 towards the left. In some implementations, the variance slider 40 is referred to as a creative liberty selector where sliding towards the left results in less creative liberty (e.g., suggested inputs are within a threshold similarity of the text prompt) and sliding towards the right results in more creative liberty (e.g., suggested inputs are outside the threshold similarity of the text prompt).

The user interface 30 includes a preview button 42 that allows the user 12 to view a 2D preview of the 3D environment before the system 200 constructs the 3D environment. Viewing the 2D preview of the 3D environment before the system 200 constructs the 3D environment allows the user 12 to refine his/her request thereby resulting in a more desirable version of the 3D environment which may not need editing or may require fewer resource-intensive edits. In some implementations, the user interface 30 additionally includes a button for generating the 3D environment while skipping the option to view a 2D preview of the 3D environment.

Referring to FIG. 1B, the device 20 detects a user selection 44 of the second image 32b. The user selection 44 of the second image 32b corresponds to a request to create a 3D environment based on the second image 32b. For example, the user selection 44 of the second image 32b corresponds to a request to generate a 3D environment that resembles the look-and-feel of the second image 32b.

Referring to FIG. 1C, after receiving the user selection 44 shown in FIG. 1B, the user interface 30 varies a visual property of the second image 32b to indicate that the second image 32b has been selected as a basis to generate a 3D environment. For example, the second image 32b is displayed with a thicker border. In the example of FIG. 1C, the second image 32b is an image of a campanile (e.g., a bell tower). In addition to indicating a selection of the second image 32b, the device 20 detects that a prompt 46 has been entered into the text box 36 (e.g., “make it an evil lair”).

In some implementations, the prompt 46 includes an instruction for the system 200 on how to use the second image 32b to create a 3D environment. In some implementations, the prompt 46 provides more details regarding the desired 3D environment (e.g., details that may not be encapsulated in the second image 32b). For example, the second image 32b may depict an innocent looking campanile and the prompt 46 specifies to make sufficient changes such that the campanile in the 3D environment looks like an evil lair (e.g., a headquarters of a villain from a movie).

Referring to FIG. 1D, after receiving the prompt 46, the system 200 generates and displays suggested inputs 48 that further characterize (e.g., elaborate or expand upon) the prompt 46. In some implementations, the system 200 determines that the prompt 46 includes an ambiguity and the suggested inputs 48 resolve the ambiguity. For example, the prompt 46 may include a vague term and the suggested inputs 48 provide more specificity to the vague term. In the example of FIG. 1D, the suggested inputs 48 include a first suggested input 48a, a second suggested input 48b and a third suggested input 48c. Although FIG. 1D illustrates three suggested inputs, additional suggested inputs are also contemplated. The first suggested input 48a is to make the sky of the 3D environment dark in order to make the 3D campanile look like an evil lair. The second suggested input 48b is to make the 3D campanile red in order to make the 3D campanile look like an evil lair. The third suggested input 48c is to make the 3D environment foggy in order to provide an ambience of an evil lair. The suggested inputs 48 are selectable. As such, the user 12 can select one or more of the suggested inputs 48 in order to integrate the selected suggested input(s) 48 into request for building the 3D environment. The user interface 30 includes a regenerate suggestions button 50 to regenerate the suggested inputs 48. Upon detecting a user selection of the regenerate suggestions button 50, the system 200 replaces the suggested inputs 48 with newly generated suggestions inputs that are different from the suggested inputs 48a, 48b and 48c.

Referring to FIG. 1E, the device 20 detects a user selection 52 of the first suggested input 48a (‘Dark Sky’). Selecting the first suggested input 48a provides the system 200 more specificity in generating a 3D environment with a 3D campanile that looks like an evil lair. Specifically, the system 200 can make the 3D campanile look like an evil lair by making the sky of the 3D environment dark.

Referring to FIG. 1F, the user interface 30 varies a visual property of the first suggested input 48a in order to indicate that the first suggested input 48a has been selected. For example, the user interface 30 displays the first suggested input 48a with a thicker border and with bold text. Since the user 12 has added the first suggested input 48a as an input for generating the 3D environment, the system 200 will use the second image 32b, the prompt 46 and the first suggested input 48a to construct the 3D environment. FIG. 1F illustrates the device 20 detecting a user selection 54 of the preview button 42. Selecting the preview button 42 corresponds to a request to view a 2D preview of the 3D environment before the system 200 utilizes at least a threshold amount of resources to construct the 3D environment.

Referring to FIG. 1G, in response to detecting the user selection 54 of the preview button 42 shown in FIG. 1F, the user interface 30 displays a 2D preview 60 of the 3D environment prior to generating the 3D environment. In the example of FIG. 1G, the 2D preview 60 includes the campanile 33 as requested by the user selection 44 of the second image 32b shown in FIG. 1B and a dark sky 62 as requested by the user selection 52 of the first suggested input 48a shown in FIG. 1E. The user interface 30 includes a generate affordance 64 that the user 12 can select in order to generate a 3D environment that will look similar to the 2D preview 60.

In the example of FIG. 1G, the user interface 30 provides the user 12 various options to edit the 2D preview 60. Editing the 2D preview 60 is less resource-intensive than editing a 3D environment. As such, providing the options to edit the 2D preview conserves resources by reducing the likelihood of the user 12 having to the edit the 3D environment after the system 200 generates the 3D environment. The user interface 30 includes suggested prompts 70 for editing the 2D preview 60 and resulting previews 72 for the suggested prompts 70. For example, the user interface 30 includes a first suggested prompt 70a to make the building black and ominous. A first resulting preview 72a shows that selecting the first suggested prompt 70a transforms the campanile 33 into a black campanile 33a. As another example, the user interface 30 includes a second suggested prompt 70b to make the campanile in the style of HR Giger. A second resulting preview 72b shows that selecting the second suggested prompt 70b transforms the campanile 33 into an HR Giger styled campanile 33b as indicated by the hatching. As yet another example, the user interface 30 includes a third suggested prompt 70c to make the campanile 33 into a crystalline building. A third resulting preview 72c shows that selecting the third suggested prompt 70c transforms the campanile 33 into a crystalline campanile 33c as indicated by the cross-hatching. As a further example, the user interface 30 includes a fourth suggested prompt 70d to surround the campanile 33 in fog. A fourth resulting preview 72d shows that selecting the fourth suggested prompt 70d surrounds the campanile 33 with virtual fog 74 as indicated by the reduced visibility of the campanile 33 in the fourth resulting preview 72d.

In the example of FIG. 1G, the user interface 30 includes a regenerate prompts button 76. A user selection of the regenerate prompts button 76 causes the device 20 to regenerate the suggested prompts 70 and their corresponding resulting previews 72. The user interface 30 includes an add prompt button 78 to add one or more of the suggested prompts 70 to the request of generating the 3D environment.

In some implementations, the 2D preview 60 is an image that represents the 3D environment that is generated when the user 12 selects the generate affordance 64. Similarly, the resulting previews 72 are representative images of respective 3D environments that can be generated by selecting the corresponding suggested prompts 70. In some implementations, the device 20 (e.g., the system 200) generates the 2D preview 60 and the resulting previews 72 and another electronic device generates the 3D environment. In some implementations, generating the 3D environment is more resource-intensive (e.g., computationally more intensive and/or more time-consuming) than generating the 2D previews and the device 20 may not have sufficient resources to generate the 3D environment. As such, another electronic device with more resources (e.g., more computational power and/or processing time) generates the 3D environment. In some implementations, the other electronic device that generates the 3D environment is coupled with the device 20 via a wired connection or via a wireless connection. As an example, the device 20 is a head-mountable device (HMD) and the other electronic device that generates the 3D environment is a smartphone, a tablet, a laptop or a desktop computer. As another example, the device 20 is an HMD, a smartphone, a tablet, a laptop or a desktop computer, and the other electronic device that generates the 3D environment is a server or a cloud computing platform.

In some implementations, the device 20 (e.g., the system 200) utilizes a first type of model to generate the 2D preview 60 and the resulting previews 72, and a second type of model to generate the 3D environment. Since the 2D preview 60 is a single image, the 2D preview 60 encodes less information that a 3D environment. As such, the first type of model tends to be more efficient and less time-consuming than the second type of model that generates the 3D environment. In some implementations, the first type of model is referred to as an on-device model that operates on the device 20 and the second type of model is referred to as an off-device model that operates on another electronic device. In some implementations, the first type of model is associated with a first level of complexity and the second type of model is associated with a second level of complexity that is greater than the first level of complexity.

Referring to FIG. 1H, the device 20 detects a user selection 80 of the first suggested prompt 70a. As shown in FIG. 1I, the device 20 changes a visual appearance of the first suggested prompt 70a in order to indicate that the first suggested prompt 70a has been selected. The device 20 detects a user selection 82 of the add prompt button 78. As shown in FIG. 1J, the user interface 30 displays an updated preview 60′ in which the campanile 33 has been replaced with the black campanile 33a. In the example of FIG. 1J, the device 20 updates the text box 36 to include the first suggested prompt 70a. As such, in FIG. 1J, the text box 36 includes the prompt 46 that the user 12 initially entered and the first suggested prompt 70a that the user 12 subsequently selected.

In FIG. 1J, the device 20 detects a user selection 90 of the fourth resulting preview 72d. The user selection 90 of the fourth resulting preview 72d represents a request to add the fourth suggested prompt 70d to the request for generating the 3D environment with the black campanile 33a. In FIG. 1K, the device 20 changes a visual property of the fourth suggested prompt 70d to indicate that the user 12 has selected the fourth suggested prompt 70d. Additionally, the device 20 detects a user selection 92 of the add prompt button 78.

FIG. 1L illustrates an updated preview 60″ in which the black campanile 33a is surrounded by virtual fog 74. In the example of FIG. 1L, the device 20 updates the text box 36 to further include the fourth suggested prompt 70d. As such, in FIG. 1L, the text box 36 includes the prompt 46 that the user 12 initially entered, the first suggested prompt 70a and the fourth suggested prompt 70d that the user 12 subsequently selected. FIG. 1L illustrates a user selection 94 of the generate affordance 64 that corresponds to a request to generate a 3D environment that resembles the updated preview 60″.

Referring to FIG. 1M, in some implementations, the device 20 displays a generation notification 100 in order to indicate that the system 200 is generating a 3D environment. The generation notification 100 may include an estimated generation time 102 (e.g., five hours). As mentioned earlier, generating the 3D environment tends to be more resource-intensive and more time-consuming than generating the 2D previews 60, 60′ and 60″ shown in FIGS. 1G, 1J and 1L, respectively.

FIG. 1N illustrates a 3D environment 110 that the system 200 generated in response to the user selection 94 of the generate affordance 64 shown in FIG. 1L. As can be seen, the 3D environment 110 resembles the updated preview 60″ shown in FIG. 1L. For example, the 3D environment 110 includes a 3D campanile 112 that is black similar to the black campanile 33a shown in FIG. 1L. The 3D environment 110 includes 3D dark clouds 114 similar to the dark sky 62 shown in FIG. 1L. The 3D environment 110 includes 3D fog 116 similar to the virtual fog 74 shown in FIG. 1L. In some implementations, the device 20 displays an edit-regenerate affordance 120 that the user 12 can select to edit and re-generate an edited version of the 3D environment 110. In some implementations, in response to detecting a selection of the edit-regenerate affordance 120, the device 20 displays the user interface 30 shown in FIG. 1L where the user 12 can view 2D previews of additional edits to the 3D environment 110. Since the user 12 has already had the opportunity to view and edit 2D previews of the 3D environment 110 prior to the 3D environment 110 being generated, the user 12 is less likely to select the edit-regenerate affordance 120 thereby conserving resources associated with regenerating the 3D environment 110.

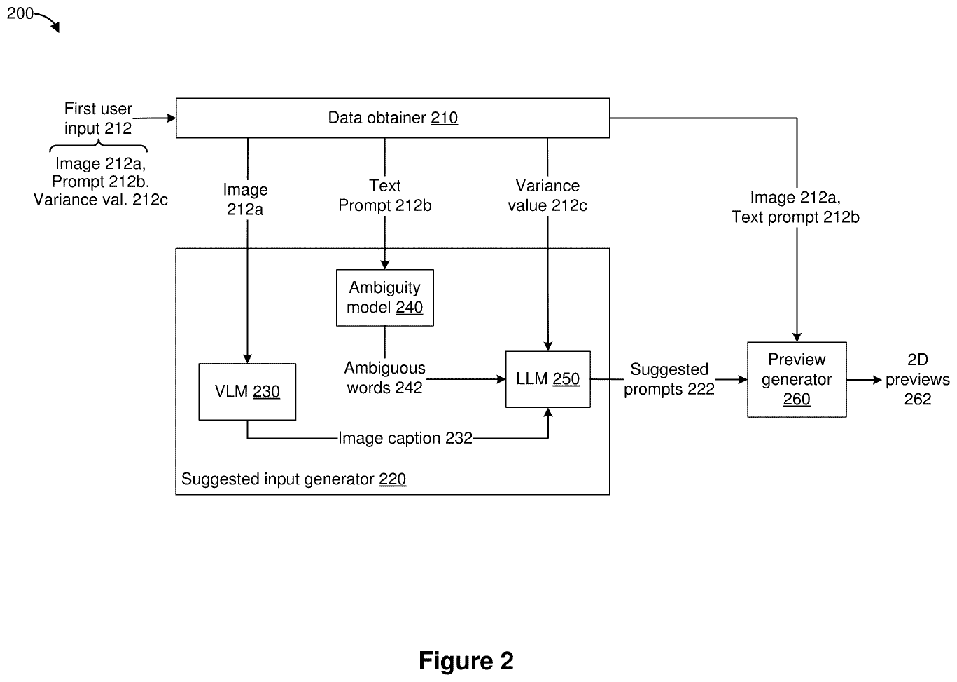

FIG. 2 is a block diagram of the system 200 in accordance with some implementations. In various implementations, the system 200 includes a data obtainer 210, a suggested input generator 220 and a preview generator 260. In various implementations, the data obtainer 210 obtains a first user input 212. The first user input 212 corresponds to a request to generate a 3D environment. The first user input 212 may be referred to as an initial request. In some implementations, the first user input 212 includes a combination of an image 212a, a text prompt 212b and a variance value 212c. In some implementations, the first user input 212 indicates the image 212a by selecting an image from an image library. For example, referring to FIG. 1B, the user 12 selects the second image 32b. In some implementations, the text prompt 212b includes a text prompt that the user provides (e.g., the prompt 46 shown in FIG. 1C). In some implementations, the variance value 212c indicates an acceptable level of deviation between suggested prompts and the text prompt 212b. For example, referring to FIG. 1D, the user 12 selects a position of the variance slider 40. The data obtainer 210 provides the image 212a, the text prompt 212b and the variance value 212c to the suggested input generator 220.

In various implementations, the suggested input generator 220 generates suggested prompts 222 based on the image 212a, the text prompt 212b and the variance value 212c. For example, referring to FIG. 1D, the suggested input generator 220 generates the suggested inputs 48. As another example, referring to FIG. 1G, the suggested input generator 220 generates the suggested prompts 70. To that effect, in various implementations, the suggested input generator 220 includes a vision language model (VLM) 230, an ambiguity model 240 and a large language model (LLM) 250.

In various implementations, the VLM 230 accepts the image 212a as an input and generates an image caption 232 for the image 212a. In some implementations, the image caption 232 describes a subject depicted in the image 212a. For example, referring to FIG. 1C, the image caption 232 for the second image 32b may state ‘campanile’ or ‘bell tower’ because the subject of the second image 32b is a campanile or bell tower. In various implementations, the VLM 230 analyzes visual elements within the image 212a, such as objects, scenes, and activities, and then contextualizes this information to generate the image caption 232 that accurately describes what is depicted in the image 212a.

In some implementations, the VLM 230 hierarchically extracts visual features from the image 212a using convolutional neural networks (CNNs). The CNNs identify and encode various elements such as objects, textures, colors, and spatial relationships within the image 212a into a feature vector. The feature vector encapsulates visual information depicted in the image 212a in a format suitable for subsequent linguistic interpretation. In some implementations, subsequent to the feature extraction, the VLM 230 utilizes recurrent neural networks (RNNs) or Transformer-based models. The RNNs or Transformer-based models decode the feature vector into a coherent sequence of words, forming the image caption 232. The decoding process may include understanding contextual relationships between the visual elements represented by the feature vector, and translating the contextual relationships into natural language.

In some implementations, the VLM 230 utilizes attention mechanisms, for example in Transformer-based models, to selectively focus on specific parts of the image 212a while generating the image caption 232. Selectively focusing on specific parts of the image 212a tends to make the image caption 232 contextually relevant to the dominant visual elements of the image 212a. In some implementations, the VLM 230 is trained on diverse datasets, encompassing a wide range of image types and descriptive captions, to enhance its generalization capabilities. In some implementations, training the VLM 230 includes setting model parameters using backpropagation and a suitable loss function, which typically measures the discrepancy between the generated captions and a set of ground-truth annotations. The VLM 230 provides the image caption 232 to the LLM 250.

In various implementations, the ambiguity model 240 identifies ambiguous words 242 in the text prompt 212b that exhibit lexical or syntactic ambiguity. In various implementations, the ambiguity model 240 utilizes methods, devices and/or systems associated with Natural Language Processing (NLP). In some implementations, the ambiguity model 240 utilizes Deep Learning architectures such as Bidirectional Encoder Representations from Transformers (BERT) or similar transformer-based models, to effectively parse and analyze the text prompt 212b.

In some implementations, the ambiguity model 240 initially tokenizes the text prompt 212b by segmenting the text prompt 212b into individual words or tokens. The ambiguity model 240 can perform a contextual analysis on each token. Performing the contextual analysis can include embedding each token into a high-dimensional space where semantically similar words are positioned closely together. In some implementations, the ambiguity model 240 is trained to recognize patterns of ambiguity by being fed a diverse array of text samples containing words with multiple meanings or syntactic constructions that could lead to different interpretations. In some implementations, the training process utilizes a corpus of annotated texts where ambiguous words or phrases are clearly identified, allowing the ambiguity model 240 to learn the nuanced characteristics of language that lead to ambiguity.

In various implementations, the ambiguity model 240 applies its learned parameters to the text prompt 212b in order to identify tokens that match the patterns of ambiguity that the ambiguity model 240 has been trained to recognize. In some implementations, ambiguous words 242 are associated with respective confidence scores or respective probability metrics indicating the likelihood of their ambiguity. In some implementations, the ambiguity model 240 generates the confidence scores based on the contextual analysis and the degree to which the token aligns with the learned patterns of ambiguity. In some implementations, the ambiguity model 240 utilizes additional layers of analysis, such as part-of-speech tagging and syntactic parsing, to identify the ambiguous words 242 in the text prompt 212b. The ambiguity model 240 provides the ambiguous words 242 to the LLM 250.

In various implementations, the LLM 250 generates the suggested prompts 222 based on the image caption 232 provided by the VLM 230 and the ambiguous words 242 provided by the ambiguity model 240. In various implementations, the LLM 250 addresses (e.g., reduces, for example, resolves) ambiguities in the text prompt 212b due to the ambiguous words 242. The LLM 250 utilizes the image caption 232 as a contextual input. As such, the suggested prompts 222 generated by the LLM 250 are contextually relevant to the image 212a. In various implementations, the LLM 250 utilizes methods, devices and/or systems associated with NLP and deep learning architectures. In some implementations, the LLM 250 utilizes methods, devices and/or systems associated with transformer-based models like GPT (Generative Pretrained Transformer) or BERT in order to process and interpret the ambiguous words 242 and the image caption 232. In various implementations, the LLM 250 is configured to identify an ambiguity in the text prompt 212b and provide guidance in resolving the identified ambiguity. In some implementations, the LLM 250 incorporates a portion of the functionality of the ambiguity model 240.

In some implementations, the LLM 250 cross-references ambiguities indicated by the ambiguous words 242 with a visual context provided by the image caption 232. Cross-referencing the ambiguities with the visual context allows the LLM 250 to generate the suggested prompts 222 such that the suggested prompts 222 provide improved resolution of the ambiguities. In some implementations, the LLM 250 is trained on a vast corpus of text and image-caption pairs. As such, the training of the LLM 250 includes language understanding and generation along with integration of visual context into the language processing task.

In some implementations, upon receiving the image caption 232 and the ambiguous words 242 as inputs, the LLM 250 activates a contextual understanding mechanism to analyze the ambiguous words 242 within the text prompt 212b in the light of the image caption 232. In some implementations, the LLM 250 generates a contextual embedding for each ambiguous word 242, taking into account the surrounding text in the text prompt 212b and the information derived from the image caption 232. After generating the contextual embedding for each ambiguous word 242, the LLM 250 employs a text generation engine (e.g., a GPT) to propose alternative wordings, phrases, or clarifications that resolve the ambiguities in the ambiguous words 242. The suggested prompts 222 are contextually coherent with the text prompt 212b and the image caption 232, ensuring that the suggested resolutions are linguistically accurate and relevant to the visual context.

In some implementations, the ambiguous words 242 indicate a desired qualitative characteristic for the requested 3D environment, and the suggested prompts 222 include quantitative values to help achieve the desired qualitative characteristic. As an example, referring to FIG. 1D, the prompt 46 indicates a desired quality of making the campanile look like an evil lair and the first suggested input 48a of making the sky dark is associated with a quantitative value in the form of a dark color value for the sky. As another example, referring to FIG. 1G, the fourth suggested prompt 70d of surrounding the campanile 33 with the virtual fog 74 may be associated with a quantitative value in the form of an opacity value that reduces viewability of the campanile 33 in order to achieve the desired effect of fogginess. In various implementations, the suggested prompts 222 includes values for color, dimensions, opacity, brightness, or other quantifiable visual characteristics of visual elements in the image 212a in order to achieve a desired effect stated by the text prompt 212b.

In various implementations, the preview generator 260 generates respective 2D previews 262 for the suggested prompts 222. Each 2D preview 262 is associated with a respective one of the suggested prompts 222 and each 2D preview 262 illustrates what a resulting 3D environment would look like were the user to select the corresponding suggested prompt 222. For example, referring to FIG. 1G, the preview generator 260 generates the resulting previews 72 for the suggested prompts 70.

In various implementations, the preview generator 260 generates each of the 2D previews 262 by modifying the image 212a based on the text prompt 212b and a corresponding one of the suggested prompts 222. For example, referring to FIG. 1G, the preview generator 260 generates the first resulting preview 72a by modifying the 2D preview 60 based on the first suggested prompt 70a (e.g., by transforming the campanile 33 into a black campanile 33a). As another example, still referring to FIG. 1G, in some implementations, the preview generator 260 generates the fourth resulting preview 72d by reducing an opacity of the 2D preview 60 in order to provide the appearance of the virtual fog 74.

In various implementations, the preview generator 260 utilizes methods, devices and/or systems associated with image modification. The preview generator 260 interprets and integrates each of the suggested prompts 222 into the image 212a in order to generate the 2D previews 262. In some implementations, the preview generator 260 includes an image processing engine that utilizes deep learning techniques to analyze and understand the content and context of the image 212a. In some implementations, the image processing engine employs convolutional neural networks to determine certain features of the image 212a, such as color schemes, object boundaries, and spatial relationships. In some implementations, the preview generator 260 includes a natural language processing module that interprets each of the suggested prompts 222 in order to determine key directives for image modification. In some implementations, the natural language processing module segments the textual prompt into actionable components in order to identify specific attributes or elements that are to be altered in the image 212a. As an example, the natural language processing module may determine to perform color adjustments, object insertion or removal, and morphological changes.

In some implementations, the preview generator 260 utilizes methods, devices and/or systems associated with image rendering to effectuate the modification identified by the image processing engine and/or the natural language processing module. As such, the preview generator 260 selectively applies alterations to the image 212a based on the parameters associated with the suggested prompt 222. The output is a 2D preview 262 that accurately embodies the modifications suggested by a corresponding one of the suggested prompts 222. The 2D previews 262 are rendered on a display (e.g., on the display of the device 20 shown in FIG. 1G).

In various implementations, the system 200 allows the user to add one or more of the suggested prompts 222 to his/her initial request to generate the 3D environment. For example, as shown in FIGS. 1H-1K, the user 12 adds the first suggested prompt 70a and the fourth suggested prompt 70d to his/her initial request to generate the 3D environment. In various implementations, the system 200 generates the 3D environment based on the initial request (e.g., the image 212a and the text prompt 212b) and one or more of the suggested prompts 222 that the user has added to the initial request. For example, as shown in FIGS. 1L-IN, the system 200 generates the 3D environment 110 based on the second image 32b, the prompt 46, the first suggested prompt 70a and the fourth suggested prompt 70d shown in FIG. 1L.

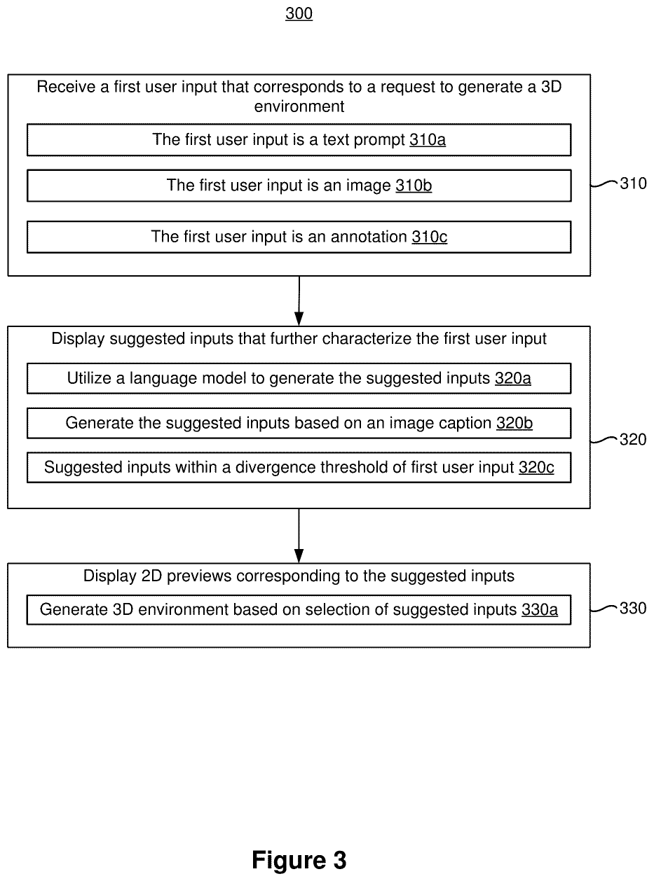

FIG. 3 is a flowchart representation of a method 300 for generating an environment. In various implementations, the method 300 is performed by the device 20 shown in FIGS. 1A-IN and/or the system 200 shown in FIGS. 1A-2. In some implementations, the method 300 is performed by processing logic, including hardware, firmware, software, or a combination thereof. In some implementations, the method 300 is performed by a processor executing code stored in a non-transitory computer-readable medium (e.g., a memory).

As represented by block 310, in various implementations, the method 300 includes receiving, via a graphical user interface (GUI), a first user input that corresponds to a request to generate a three-dimensional (3D) environment. As represented by block 310a, in some implementations, the first user input includes a first text input. For example, as shown in FIG. 1C, the device 20 detects the prompt 46 that the user 12 entered in the text box 36. In some implementations, the first text input is associated with a first set of one or more images. For example, the first text input includes a user instruction on how to use the first set of one or more images to construct a 3D environment. In some implementations, the user provides the first set of one or more images. Alternatively, in some implementations, the device identifies the first set of one or more images from a collection of images based on the first text input. For example, the device automatically selects the first set of one or more images without requiring the user to select the first set of one or more images. As an example, if the first text input is “build a scene with a scary looking tower”, the device may automatically select the second image 32b which depicts a bell tower as a starting point for constructing the requested scene.

As represented by block 310b, in some implementations, the first user input includes a first image. In some implementations, the method 300 includes detecting a selection of the first image from a set of images. For example, as shown in FIG. 1B, the device 20 detects the user selection 44 of the second image 32b from the images 32. In some implementations, the method 300 includes receiving the first image, for example, via the image upload box 34 shown in FIG. 1A. In some implementations, the first image forms a basis (e.g., a starting point) for generating the 3D environment. For example, the device may receive the first image and the first text input that specifies how to utilize the first image in generating the 3D environment.

As represented by block 310c, in some implementations, the first user input includes an annotation of a first image. In some implementations, the method 300 includes receiving the first image or a selection of the first image from a set of images, and detecting an annotation on the first image. In some implementations, detecting the annotation includes detecting a hand-drawn marking on the first image. In some implementations, the annotation modifies a visual element in the first image. In such implementations, the device generates the 3D environment such that the 3D environment includes the modification indicated by the annotation. In some implementations, the annotation removes (e.g., deletes or crosses-out) a visual element from the first image. In such implementations, the device generates the 3D environment such that the 3D environment does not include a 3D object corresponding to the visual element that the annotation removed or crossed-out. Additionally or alternatively, in some implementations, the annotation adds a new visual element to the first image. In such implementations, the device generates the 3D environment such that the 3D environment includes a 3D object that corresponds to the new visual element added by the annotation.

As represented by block 320, in some implementations, the method 300 includes, after receiving the first user input, displaying, within the GUI, suggested inputs that further characterize the first user input. For example, as shown in FIG. 1D, the device 20 displays the suggested inputs 48 that further characterize the prompt 46. As another example, as shown in FIG. 1G, the device 20 displays the suggested prompts 70 that further elaborate on the prompt 46 provided by the user 12. Generating and displaying the suggested inputs prior to generating the 3D environment allows the user to refine his/her request for generating the 3D environment so that when the 3D environment is generated the 3D environment is closer to a target 3D environment (e.g., an expected 3D environment) that requires fewer revisions (e.g., no revisions) thereby conserving resources associated with re-generating the 3D environment.

As represented by block 320a, in some implementations, the method 300 includes utilizing a language model to generate the suggested inputs that are displayed within the GUI after receiving the first user input. For example, as described in relation to FIG. 2, the system 200 utilizes the suggested input generator 220 to generate the suggested inputs 48 shown in FIG. 1D and the suggested prompts 70 shown in FIG. 1G. In some implementations, the language model includes an ambiguity model that detects lexical and/or syntactic ambiguities in the first user input, and the suggested inputs reduce (e.g., resolve) the ambiguities detected by the ambiguity model. For example, as shown in FIG. 2, the system 200 includes the ambiguity model 240 that detects ambiguities in the text prompt 212b.

In some implementations, the suggested inputs resolve an ambiguity in the first user input by clarifying an ambiguous word in the first user input. In some implementations, the language model generates respective ambiguity scores for each of the suggested words and clarifies one of the words with an ambiguity score that is greater than a threshold ambiguity score. For example, referring to FIG. 2, the ambiguity model 240 generates respective ambiguity scores for each word in the text prompt 212b and the ambiguous words 242 are a subset of the words in the text prompt 212b with ambiguity scores that are above an acceptability threshold. Still referring to the example of FIG. 2, the LLM 250 generates the suggested prompts 222 in order to reduce the ambiguity in the ambiguous words 242.

In some implementations, the method 300 includes clarifying an ambiguous word by suggested a quantitative value for a qualitative property. In some implementations, the method 300 includes generating a suggested color value for a qualitative term in the first user input. For example, referring to FIG. 1F, in order to make the campanile 33 look like an ‘evil lair’ the system 200 (e.g., the LLM 250 shown in FIG. 2) generates the first suggested input 48a which suggests a dark sky for the 3D environment (e.g., by setting a color value of the sky to black or dark gray). As another example, referring to FIG. 1G, in order to make the campanile 33 look like an ‘evil lair’ the system 200 (e.g., the LLM 250 shown in FIG. 2) generates the first suggested prompt 70a which suggests making the building black (e.g., by setting a color value of the campanile 33 to black).

In some implementations, the method 300 includes generating a suggested size value for an object based on a qualitative term in the first user input being used to describe the object. For example, the device can suggest a relatively large size value for an object in response to the first user input describing the object as grand, majestic, monumental, magnificent, substantial, sizable or expansive. As another example, the device can suggest a relatively small size value for an object in response to the first user input describing the object as minimal, compact, miniature, diminutive, microscopic, streamlined, subtle or modest.

In some implementations, the method 300 includes generating suggested inputs that provide more specificity for an object referenced in the first user input. As an example, the suggested inputs can provide specificity in terms of a stylistic characteristic of the object. For example, as shown in FIG. 1G, the second suggested prompt 70b is to make the campanile 33 in the style of HR Giger and the third suggested prompt 70c is to make the campanile 33 into a crystalline building.

In some implementations, the method 300 includes generating suggested inputs that provide placement locations and/or placement orientations for the object in the 3D environment in order to achieve a desired effect specified in the first user input. In some implementations, the method 300 includes generating suggested inputs that indicate whether to make the object static or dynamic in the 3D environment. As an example, one of the suggested inputs may include making window shutters of the campanile automatically move when the wind blows in order to make the campanile look scarier. As another example, another one of the suggested inputs may include making the window shutters creak when the window shutters move in order to make the campanile look and sound even scarier. To that end, in various implementations, the suggested inputs include adding sound effects to the 3D environment.

In some implementations, the method 300 includes generating suggested inputs that provide environmental characteristics for the 3D environment. For example, as shown in FIG. 1G, the fourth suggested prompt 70d is to surround the campanile 33 with virtual fog 74. In some implementations, the environmental characteristics indicated by the suggested prompts are a function of weather conditions specified in the first user input. For example, when the first user input mentions cold or snow, one of the suggested inputs can include making it snow in the 3D environment in order to provide an appearance that a climate of the 3D environment is cold or snowy.

As represented by block 320b, in some implementations, the first user input includes an image or a selection of the image from a plurality of images. For example, as shown in FIG. 1B, the device 20 detects the user selection 44 selecting the second image 32b from the set of images 32. In such implementations, generating the suggested inputs includes generating an image caption for the image and generating the suggested inputs based on the image caption. For example, as shown in FIG. 2, the VLM 230 generates the image caption 232 for the image 212a and the LLM 250 utilizes the image caption 232 to generate the suggested prompts 222. As described in relation to FIG. 2, since the image caption describes the visual elements depicted in the image, utilizing the image caption tends to result in suggested inputs that are contextually relevant to the visual elements depicted in the image. As such, the suggested inputs include suggested changes that are feasible and not suggested changes that are infeasible (e.g., suggestions to modify visual elements that are depicted in the image and not visual elements that are not even depicted in the image).

As represented by block 320c, in various implementations, the suggested inputs are within a divergence threshold of the first user input. In some implementations, the method 300 includes receiving the divergence threshold as a part of the first user input or in association with the first user input. For example, as shown in FIG. 1A, the user 12 can slide the variance slider 40 towards the left to reduce a value of the divergence threshold (e.g., the variance value 212c shown in FIG. 2) and slide the variance slider 40 towards the right to increase the divergence threshold (e.g., the variance value 212c shown in FIG. 2). In some implementations, a relatively low value for the divergence threshold results in suggested inputs that are within a similarity threshold of the first user input and a relatively high value for the divergence threshold results in suggested inputs that are beyond the similarity threshold of the first user input.

In some implementations, the method 300 includes utilizing a large language model (LLM) to generate the suggested inputs. For example, as shown in FIG. 2, the LLM 250 generates the suggested prompts 222. In various implementations, the LLM accepts an image caption and ambiguities in a text prompt as inputs, and outputs the suggested prompts. For example, the LLM 250 shown in FIG. 2 accepts the image caption 232 and the ambiguities identified by the ambiguity model 240 (e.g., ambiguous words 242) as inputs and outputs the suggested prompts 222. In some implementations, the LLM additionally accepts a divergence threshold as an input and generates the suggested prompts such that the suggested prompts do not diverge from the text prompt beyond the divergence threshold. In some implementations, the method 300 includes adjusting parameter values for the LLM based on a value of the divergence threshold. For example, referring to FIG. 2, the system 200 adjusts configuration parameter values for the LLM 250 based on the variance value 212c.

As represented by block 330, in various implementations, the method 300 includes displaying two-dimensional (2D) previews of the 3D environment prior to generating the 3D environment. In some implementations, each 2D preview is associated with a corresponding one of the suggested inputs. As described in relation to FIG. 2, the 2D previews provide a visual indication of how the 3D environment may appear when the corresponding suggested prompts 222 are provided as an input for generating the 3D environment. For example, as shown in FIG. 1G, the device 20 displays the resulting previews 72 for the suggested prompts 70 in order to provide a visual indication of how each of the suggested prompts 70 would affect the 3D environment.

As represented by block 330a, in some implementations, the method 300 includes receiving, via the GUI, a second user input that selects at least one of the suggested inputs, and generating the 3D environment based on the first user input and the second user input. For example, as shown in FIG. 1H, the device 20 detects the user selection 80 of the first suggested prompt 70a to make the campanile 33 black and ominous. Continuing with this example, as shown in FIG. 1N, the 3D environment 110 includes a 3D campanile 112 that is black due to the user selection 80 of the first suggested prompt 70a shown in FIG. 1H.

In some implementations, the second user input has a greater degree of specificity than the first user input. For example, referring to FIG. 1H, while the prompt 46 states to make the campanile 33 look like ‘an evil lair’, the user selection 80 of the first suggested prompt 70a provides more specificity as to how to make the campanile 33 look like an evil lair (e.g., by making the campanile 33 black). In some implementations, the first user input specifies a qualitative property (e.g., a look and feel, for example, “make it an evil lair”) of an object and the second user input specifies a quantitative property (e.g., a color, for example, “make it black”) of the object. In some implementations, the first user input specifies a first target property that results in a first number of possible configurations for the 3D environment and the second user input specifies a second target property that reduces the first number of possible configurations to a second number of possible configurations.

In some implementations, generating the 3D environment includes utilizing a neural radiance field (NeRF) to generate the 3D environment. For example, referring to FIG. 2, in some implementations, the suggested input generator 220 utilizes a set of one or more NeRFs to generate the suggested prompts 222.

In some implementations, the method 300 includes receiving a selection of a plurality of the 2D previews, and generating the 3D environment based on the selection of the plurality of the 2D previews. For example, as shown in FIGS. 1H-IN, the device 20 detects user selections of the first suggested prompt 70a and the fourth suggested prompt 70d, and the system 200 generates the 3D environment 110 such that the 3D environment 110 includes the changes suggested by the first suggested prompt 70a (e.g., making the 3D campanile 112 black) and the fourth suggested prompt 70d (e.g., surrounding the 3D campanile 112 with 3D fog 116).

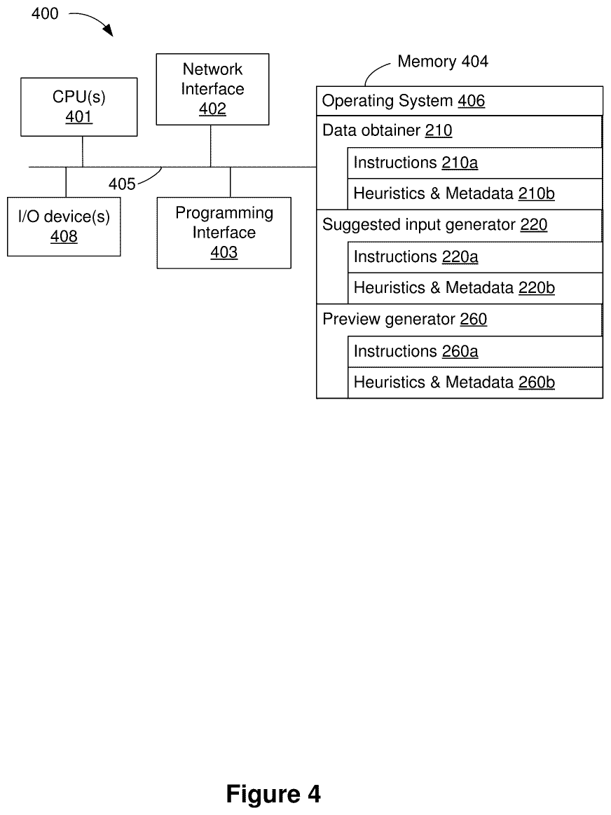

FIG. 4 is a block diagram of a device 400 in accordance with some implementations. In some implementations, the device 400 implements the device 20 shown in FIGS. 1A-1N and/or the system 200 shown in FIGS. 1A-2. While certain specific features are illustrated, those of ordinary skill in the art will appreciate from the present disclosure that various other features have not been illustrated for the sake of brevity, and so as not to obscure more pertinent aspects of the implementations disclosed herein. To that end, as a non-limiting example, in some implementations the device 400 includes one or more processing units (CPUs) 401, a network interface 402, a programming interface 403, a memory 404, one or more input/output (I/O) devices 408, and one or more communication buses 405 for interconnecting these and various other components.

In some implementations, the network interface 402 is provided to, among other uses, establish and maintain a metadata tunnel between a cloud hosted network management system and at least one private network including one or more compliant devices. In some implementations, the one or more communication buses 405 include circuitry that interconnects and controls communications between system components. The memory 404 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. The memory 404 optionally includes one or more storage devices remotely located from the one or more CPUs 401. The memory 404 comprises a non-transitory computer readable storage medium.

In some implementations, the one or more I/O devices 408 include a display for displaying the user interface 30 shown in FIGS. 1A-1M and the 3D environment 110 shown in FIG. 1N. In some implementations, the display includes an extended reality (XR) display. In some implementations, the display includes an opaque display. Alternatively, in some implementations, the display includes an optical see-through display. In some implementations, the one or more I/O devices 408 include an image sensor (e.g., a visible light camera) for capturing image data (e.g., the image 212a shown in FIG. 2). In some implementations, the one or more I/O devices 408 include an audio sensor (e.g., a microphone) for receiving an audible signal and converting the audible signal into electronic signal data. In some implementations, the one or more I/O devices 408 include a touchscreen for receiving a text prompt (e.g., the prompt 46 shown in 1C).

In some implementations, the memory 404 or the non-transitory computer readable storage medium of the memory 404 stores the following programs, modules and data structures, or a subset thereof including an optional operating system 406, the data obtainer 210, the suggested input generator 220 and the preview generator 260.

In various implementations, the data obtainer 210 includes instructions 210a, and heuristics and metadata 210b for obtaining the various user selections illustrated in FIGS. 1B-1L and/or the first user input 212 shown in FIG. 2. In some implementations, the suggested input generator 220 includes instructions 220a, and heuristics and metadata 220b for generating the suggested inputs 48 shown in FIG. 1D, the suggested prompts 70 shown in FIG. 1G and/or the suggested prompts 222 shown in FIG. 2. In some implementations, the preview generator 260 includes instructions 260a, and heuristics and metadata 260b for generating and displaying the resulting previews 72 shown in FIG. 1G and/or the 2D previews 262 shown in FIG. 2.

It will be appreciated that FIG. 4 is intended as a functional description of the various features which may be present in a particular implementation as opposed to a structural schematic of the implementations described herein. As recognized by those of ordinary skill in the art, items shown separately could be combined and some items could be separated. For example, some functional blocks shown separately in FIG. 4 could be implemented as a single block, and the various functions of single functional blocks could be implemented by one or more functional blocks in various implementations. The actual number of blocks and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

What is claimed is:

1. A method comprising:
at an electronic device including a display, an input device, a non-transitory memory and one or more processors:
receiving, via a graphical user interface (GUI), a first user input that corresponds to a request to generate a three-dimensional (3D) environment;
after receiving the first user input, displaying, within the GUI, suggested inputs that further characterize the first user input; and
displaying two-dimensional (2D) previews of the 3D environment prior to generating the 3D environment, wherein each 2D preview is associated with a corresponding one of the suggested inputs.

2. The method of claim 1, wherein displaying the suggested inputs comprises utilizing a language model to generate the suggested inputs.

3. The method of claim 2, wherein the suggested inputs resolve an ambiguity in the first user input by clarifying an ambiguous word in the first user input.

4. The method of claim 1, wherein the first user input comprises an image or a selection of the image from a plurality of images; and
wherein generating the suggested inputs comprises:
generating an image caption for the image; and
generating the suggested inputs based on the image caption.

5. The method of claim 1, wherein the suggested inputs are within a divergence threshold of the first user input.

6. The method of claim 1, further comprising:
receiving, via the GUI, a second user input that selects at least one of the suggested inputs; and
generating the 3D environment based on the first user input and the second user input.

7. The method of claim 6, wherein generating the 3D environment comprises utilizing a neural radiance field (NeRF) to generate the 3D environment.

8. The method of claim 1, further comprising:
receiving a selection of a plurality of the 2D previews; and
generating the 3D environment based on the selection of the plurality of the 2D previews.

9. The method of claim 1, wherein the suggested inputs are generated by a large language model (LLM).

10. The method of claim 1, wherein the first user input includes a first text input.

11. The method of claim 10, wherein the first text input is associated with a first set of one or more images.

12. The method of claim 11, wherein the user provides the first set of one or more images.

13. The method of claim 11, wherein the device identifies the first set of one or more images from a collection of images based on the first text input.

14. The method of claim 1, wherein the first user input includes a first image.

15. The method of claim 1, wherein the first user input includes an annotation of a first image.

16. The method of claim 1, wherein each 2D preview is an image.

17. The method of claim 1, wherein the 2D previews are generated by the electronic device and the 3D environment is generated by a second electronic device.

18. The method of claim 1, wherein the 2D previews are generated using a first model and the 3D environment is generated using a second model that is different from the first model.

19. A device comprising:
a display;
an input device;
one or more processors;
a non-transitory memory; and
one or more programs stored in the non-transitory memory, which, when executed by the one or more processors, cause the device to:
receive, via a graphical user interface (GUI), a first user input that corresponds to a request to generate a three-dimensional (3D) environment;
after receiving the first user input, display, within the GUI, suggested inputs that further characterize the first user input; and
display two-dimensional (2D) previews of the 3D environment prior to generating the 3D environment, wherein each 2D preview is associated with a corresponding one of the suggested inputs.

20. A non-transitory memory storing one or more programs, which, when executed by one or more processors of a device with an input device and a display, cause the device to:
receive, via a graphical user interface (GUI), a first user input that corresponds to a request to generate a three-dimensional (3D) environment;
after receiving the first user input, display, within the GUI, suggested inputs that further characterize the first user input; and
display two-dimensional (2D) previews of the 3D environment prior to generating the 3D environment, wherein each 2D preview is associated with a corresponding one of the suggested inputs.
